(19) United States
(12) Patent Application Publication
(10) Pub. No.: US 2026/0211791 A1
(43) Pub. Date: Jul. 23, 2026

(54) SYSTEMS AND METHOD FOR AUTOMATED HEALTH ASSESSMENT OF DISTRIBUTED COMPUTING NODES USING RANDOMIZED NODE SAMPLING AND SEEDING PAIR EVALUATION

(71) Applicant: Penguin Computing, Inc., Fremont, CA (US)

(72) Inventors: Nicholas Mccollum, Decatur, AL (US); Kevin Manalo, Saint Johns, FL (US)

(73) Assignee: Penguin Computing, Inc., Fremont, CA (US)

(21) Appl. No.: 19/033,661

(22) Filed: Jan. 22, 2025

(51) Int. Cl. G06F 11/34; G06F 11/30

(52) U.S. Cl. CPC G06F 11/3495; G06F 11/3006; G06F 11/3428

(57) ABSTRACT

A system and method for initializing and executing an automated node health assessment in a cluster of computing nodes is disclosed. The method includes randomly sampling trial pairs of computing nodes from a cluster. A trial node health assessment is performed on the trial pairs, involving bi-directional testing to evaluate performance metrics. Trial testing data is analyzed to identify a seeding pair of computing nodes meeting performance stability thresholds. The seeding pair serves as a benchmark for initializing an automated node health assessment across the entire cluster. The automated node health assessment propagates through the cluster, leveraging the seeding pair's performance metrics to evaluate other computing nodes, ensuring comprehensive cluster diagnostics. The method enhances cluster efficiency and reliability by rejecting anomalous nodes thereby minimizing performance variability and ensuring multi-node jobs are efficient in using reliable hardware.

### TECHNICAL FIELD

The present application relates to the technical field of distributed computing systems and, more particularly, to systems and methods for performing automated health assessments of computing nodes within a distributed cluster of computing nodes. The disclosed embodiments involve techniques for identifying idle or underutilized computing nodes, conducting randomized sampling of node pairs, performing trial health assessments based on performance metrics, and initializing a cluster-wide health assessment using a verified seeding pair of computing nodes. The described techniques address challenges related to ensuring operational stability, minimizing resource contention, and enhancing the reliability of distributed systems by dynamically monitoring and evaluating node health based on performance thresholds.

### BACKGROUND

Traditional methods for assessing the health and performance of computing clusters often rely on passive reporting mechanisms such as error logs, system messages, or self-reported hardware failures from individual computing nodes. These methods depend on a node's ability to self-diagnose and report issues, leading to a significant limitation: failures that do not generate error messages or self-report can remain undetected, causing undiagnosed performance degradation across the cluster.

Some existing systems attempt to address this issue using single-point health checks, typically provided by hardware vendors. These checks focus on monitoring the operational status of individual computing nodes but often fail to detect subtle hardware failures, intermittent faults, or degraded performance in network connectivity between nodes. Additionally, single-point health checks can overlook issues affecting the integrity of the cluster's high-speed interconnect infrastructure, such as those using fiber optics, direct-attached copper (DAC), or similar technologies, which can lead to unacknowledged bottlenecks and latency issues within the cluster.

Furthermore, conventional health checks often suffer from deterministic test orders where the same node or component may repeatedly be tested first, potentially introducing bias in fault detection. For example, when a cluster depends on an “accumulator” method for fault identification, the selection of the first node can skew test results if the first node tested is underperforming.

The techniques described herein address these shortcomings by introducing a randomized and trial-based node health assessment framework for distributed computing clusters. This approach includes randomizing the selection of nodes for health testing and introducing trial sampling to mitigate biases in fault detection processes. By shuffling node pairings and running multiple trials, the system ensures diverse node participation, increasing the likelihood of identifying underperforming nodes without relying on error self-reporting.

Accordingly, there is a technical need for an automated, dynamic, and scalable system and method for performing comprehensive node health assessments within a distributed computing cluster. Such a system should be capable of identifying idle or underperforming nodes, conducting trial assessments on a subset of randomly sampled computing nodes, and initializing a full-cluster node health assessment based on seeding pairs that demonstrate stable performance characteristics.

### SUMMARY OF THE EMBODIMENTS OF THE PRESENT APPLICATION

A method for initializing an automated computing node health assessment based on computing nodes randomly sampled from a cluster of computing nodes includes randomly sampling, by an automated task scheduler, a plurality of trial pairs of computing nodes from a cluster of computing nodes. The method further includes executing, by the automated task scheduler, a trial node health assessment for each of the plurality of trial pairs of computing nodes, wherein the trial node health assessment includes executing a bi-directional testing between computing nodes within each of the plurality of trial pairs of computing nodes. The method also includes evaluating trial testing data obtained based on the execution of the trial node health assessment, identifying at least one trial pair of the plurality of trial pairs of computing nodes as a seeding pair of computing nodes for initializing an automated node health assessment of an entirety of the cluster of computing nodes, initializing the automated node health assessment based on performance metrics of the seeding pair of computing nodes satisfying one or more performance stability thresholds, and executing the automated node health assessment of the cluster of computing nodes based on the initialization using the seeding pair.

In one embodiment, initializing the automated node health assessment includes setting the seeding pair of computing nodes as an initial or a first set of computing nodes for executing the automated node health assessment and setting performance metrics obtained from an assessment of the seeding pair under the automated node health assessment as one or more benchmarks of performance for evaluating a performance of test pairs of computer nodes of the cluster of computing nodes.

In one embodiment, the method further comprises identifying at least one pair of the plurality of trial pairs of computing nodes as an anomalous pair of computing nodes based on the anomalous pair of computing nodes failing to satisfy the one or more performance stability thresholds and, in response to identifying the anomalous pair of computing nodes, automatically re-executing the random sampling of a new plurality of trial pairs of computing nodes from the cluster of computing nodes and further executing the trial node health assessment using the new plurality of trial pairs of computing nodes.

In one embodiment, the method further includes bypassing or avoiding an assignment of one or more computing nodes of the anomalous pair of computing nodes as one or more seeding pairs of computing nodes used for initializing the automated node health assessment.

In one embodiment, randomly sampling from the cluster of computing nodes includes randomly sampling computing nodes from multiple distinct pods of computing nodes, wherein each pod of the multiple distinct pods of computing nodes includes a plurality of computing nodes and wherein the multiple distinct pods of computing nodes are interconnected via a communication spine, wherein at least a subset of trial pairs of the plurality of trial pairs of computing nodes comprises computing nodes from distinct pods of the multiple distinct pods.

In one embodiment, randomly sampling from the cluster of computing nodes includes randomly sampling computing nodes of the cluster of computing nodes that are located along a boundary of a pod of computing nodes and wherein at least a subset of trial pairs of the plurality of trial pairs of computing nodes comprises computing nodes from the boundary of a pod of computing nodes.

In one embodiment, the random sampling includes dynamically adjusting node selection based on historical performance data and operational status of computing nodes within the cluster of computing nodes.

In one embodiment, the method further comprises prioritizing the inclusion of computing nodes with historically stable performance metrics in the plurality of trial pairs to enhance the reliability of the trial node health assessment.

In one embodiment, the method further comprises generating diagnostic alerts for trial pairs exhibiting performance metrics below predefined stability thresholds and automatically excluding such trial pairs from subsequent seeding pair selection.

In one embodiment, the automated node health assessment includes assessing intra-cluster communication performance by evaluating cross-pod latency and throughput between interconnected computing nodes.

In one embodiment, the method further comprises dynamically updating performance stability thresholds used for seeding pair determination based on real-time feedback from ongoing node health assessments.

In one embodiment, the execution of the automated node health assessment includes leveraging a hierarchical topology of the cluster of computing nodes to sequentially assess subsets of nodes within defined network segments.

A system for initializing an automated computing node health assessment within a cluster of computing nodes comprises a cluster of computing nodes configured to perform distributed computing operations, and an automated task scheduler communicatively coupled to the cluster of computing nodes, wherein the automated task scheduler is configured to randomly sample a plurality of trial pairs of computing nodes from the cluster of computing nodes, execute a trial node health assessment for each of the plurality of trial pairs of computing nodes, wherein the trial node health assessment includes bi-directional testing between computing nodes within each of the plurality of trial pairs of computing nodes, evaluate trial testing data obtained based on the execution of the trial node health assessment, identify at least one trial pair of the plurality of trial pairs of computing nodes as a seeding pair of computing nodes based on performance metrics of the trial pairs satisfying or exceeding one or more performance stability thresholds, initialize an automated node health assessment of the cluster of computing nodes using the seeding pair of computing nodes as a reference for health evaluation, and execute the automated node health assessment across the entirety of the cluster of computing nodes based on the initialization using the seeding pair of computing nodes. The system further comprises a cluster health evaluation module configured to analyze and store performance metrics and node health assessment results for the cluster of computing nodes in a cluster health repository.

The system wherein initializing the automated node health assessment includes setting the seeding pair of computing nodes as an initial or a first set of computing nodes for executing the automated node health assessment and setting performance metrics obtained from an assessment of the seeding pair under the automated node health assessment as one or more benchmarks of performance for evaluating a performance of test pairs of computer nodes of the cluster of computing nodes.

The system wherein the automated task scheduler is further configured to identify at least one pair of the plurality of trial pairs of computing nodes as an anomalous pair of computing nodes based on the anomalous pair of computing nodes failing to satisfy the one or more performance stability thresholds and, in response to identifying the anomalous pair of computing nodes, automatically re-execute the random sampling of a new plurality of trial pairs of computing nodes from the cluster of computing nodes and further executing the trial node health assessment using the new plurality of trial pairs of computing nodes.

The system further comprises bypassing or avoiding an assignment of one or more computing nodes of the anomalous pair of computing nodes as one or more seeding pairs of computing nodes used for initializing the automated node health assessment.

The system wherein randomly sampling from the cluster of computing nodes includes randomly sampling computing nodes from multiple distinct pods of computing nodes, wherein each pod of the multiple distinct pods of computing nodes includes a plurality of computing nodes, and wherein the multiple distinct pods of computing nodes are interconnected via a communication spine, and wherein at least a subset of trial pairs of the plurality of trial pairs of computing nodes comprises computing nodes from distinct pods of the multiple distinct pods.

### BRIEF DESCRIPTION OF THE FIGURES

FIG. 1 illustrates a schematic representation of a system in accordance with one or more embodiments of the present application;

FIG. 1A illustrates a schematic representation of a subsystem of the system in accordance with one or more embodiments of the present application;

FIG. 2 illustrates an example method in accordance with one or more embodiments of the present application;

FIG. 3 illustrates an example schematic for identifying a target set of computing nodes of a cluster of computing nodes in accordance with one or more embodiments of the present application;

FIG. 4 illustrates an example schematic for submitting an initial health tests of a node health assessment in accordance with one or more embodiments of the present application;

FIG. 5 illustrates an example schematic executing the initial health tests within a pair of computing nodes in accordance with one or more embodiments of the present application;

FIG. 6 illustrates an example schematic for submitting additional health tests or discovery tests in accordance with one or more embodiments of the present application; and

FIG. 7 illustrates an example schematic for submitting additional health tests or confirmatory tests for confirming a state of a likely faulty computing node in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Enhanced Cluster Health Management and Unhealthy Node Detection

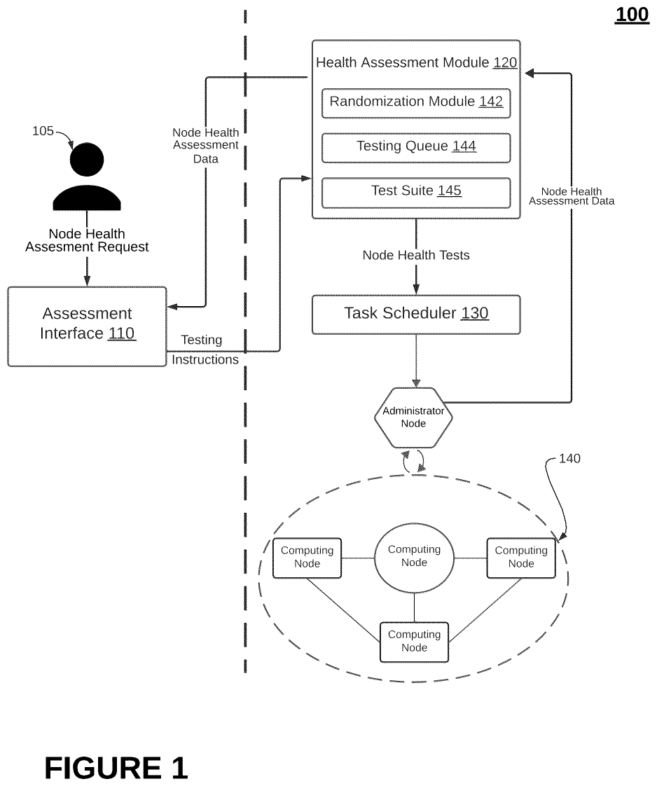

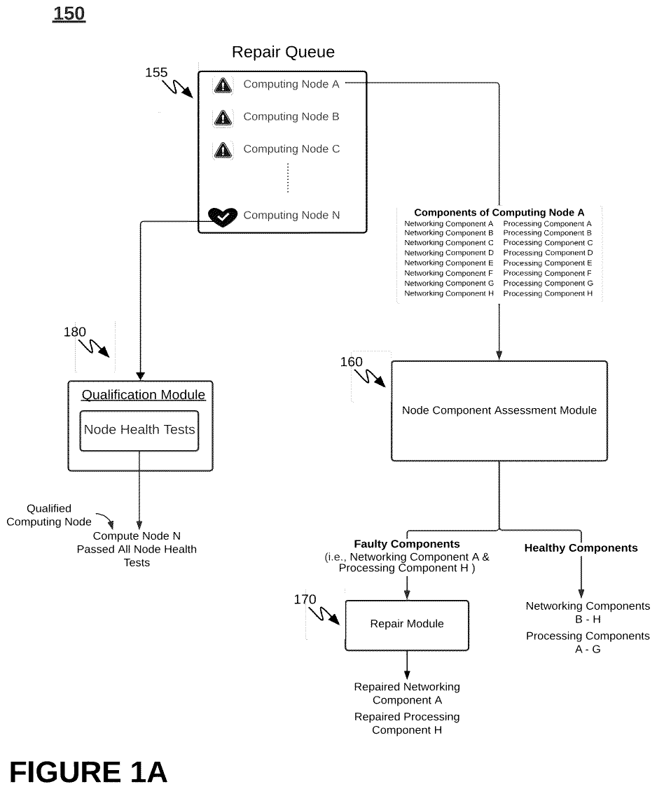

As shown in FIG. 1, a system 100 implementing enhanced cluster health management and for detecting unhealthy computing nodes within a cluster of computer nodes includes a node health assessment interface 110, a health assessment module 120, and a task scheduler 130 for assessing the health of a cluster of computing nodes 140.

### 1.1 Computing Node Health Assessment Interface

The node health assessment interface 110, which may also be referred to herein as assessment interface 110, preferably includes a command interface or system programming interface or console through which an administrator 105 may operate to execute a node health assessment of a target cluster of computing nodes 140. In a preferred embodiment, the node health assessment interface 110 is preferably implemented by one or more computers and may be in operable control communication with one or more computing nodes of a target cluster of computing systems. In such preferred embodiment, the node health assessment interface 110 may function to receive, as input, one or more user commands for executing one or more aspects of a node health assessment of a target cluster of computing nodes 140 and output control signals to the one or more computing nodes of the target cluster of computing nodes 140.

In one or more embodiments, the one or more computing nodes of a target cluster of computing nodes 140 that may be operably controlled via the node health assessment interface 110 preferably include an administrator node. In such embodiments, the administrator node comprises one computing node of the target cluster of computing nodes 140 that may be in network communication with all computing nodes of the target cluster of computing nodes 140. The administrator node executing commands or instructions from the node health assessment interface 110 may function to administer any suitable tests to the target cluster of computing nodes 140 including, but not limited to, a node health assessment. In some embodiments, the administrator node may be referred to herein as a head node or a control node depending on its operation within the cluster of computing nodes 140. Accordingly, the administrator node 105 may have installed cluster management software or similar applications that preferably enables the administrator node 105 to coordinate activities of the cluster of computing nodes 140, manage resource allocation, perform scheduling (e.g., integrated scheduler 130), and/or support maintaining an overall health of the cluster of computing nodes 140.

Additionally, or alternatively, the administrative node may be in operable control communication of a parallel file system or the like for administering any suitable tests, including a node health assessment, to a target cluster of computing nodes 140. Additionally, or alternatively, the administrative node may include an assessment agent installed thereon that may be in communication and operably controlled via commands from the node health assessment interface 110. In some embodiments, the node health assessment agent of the administrator node based on command inputs from the node health assessment interface 110 may function to automatically execute one or more operations or functions of a node health assessment against a target cluster of computing nodes 140.

### 1.2 Health Assessment Module

The health assessment module 120, in one or more embodiments, which is in operable communication with one or more of the node health assessment interface 110, the node assessment scheduler 130, and cluster of computing nodes 140 may operate to configure one or more node health assessments and/or execute one or more node health assessments against a target set of computing nodes of the cluster of computing nodes 140. In one or more embodiments, the health assessment module 120 may function to store and/or have access to a test suite 145, which is sometimes referred to herein as a pool of node health tests, that includes a plurality of node health tests. At runtime, the health assessment module 120 may function to source from the test suite 145 one or more node health tests, which may be executed either serially or in parallel against computing nodes of the cluster of computing nodes 140.

In one or more embodiments, the health assessment module 120 may be implemented in cooperation with a network file system, a parallel file system or the like. In such embodiments, the health assessment module 120 may be implemented by an administrative computing node of a target cluster of computing nodes, the administrative computing node may be sometimes referred to herein as a “head node” or “node zero”. Additionally, or alternatively, each computing node in the target cluster of computing nodes may store a copy of the tests and/or assessments associated with an operation of the health assessment module 120. In this way, commands and/or signals from the health assessment module 120 may cause any or each of the computing nodes of the target cluster to access one or more tests and/or assessments and execute the tests or assessments concurrently. In such embodiments, the outputs of the execution of the tests and/or assessments by the target cluster of computing nodes may be stored to or served out to the network file system.

Additionally, or alternatively, the health assessment module 120 may function to implement and/or include one or more of a randomization module 142 and a testing queue 144 that may operate together for initializing and executing a node health assessment of computing nodes of a cluster of computing nodes 140. In one or more embodiments, the randomization module 142 may function to ensure that different first computing nodes are seeded to prevent biased results on the basis of an initial computing node selection from a batch of computing nodes subject to a node health assessment.

The randomization module 142, in accordance with one or more embodiments of the present application, functions to facilitate randomized node selection and trial sampling for enhanced fault detection in a distributed computing cluster. The randomization module 142, as shown in FIG. 1, is operatively coupled to the health assessment module 120 and the task scheduler 130 to ensure unbiased node selection during pre-job health testing, thereby preventing deterministic node ordering from skewing fault detection results.

In a preferred embodiment, the Randomization Module 142 includes a trial sampling sub-module that performs multiple randomized iterations of node health assessments on a defined subset of nodes from the target set of computing nodes 140. The trial sampling sub-module may function to shuffle the order of node pairings prior to each iteration, ensuring that no single node is repeatedly tested in a fixed sequence. This randomized approach prevents test bias caused by the repeated selection of a specific node as the first in a test cycle, which could otherwise mask the identification of underperforming nodes.

Additionally, or alternatively, the randomization module 142 may operate by generating a random seed or randomized index for node selection. The generated random seed may be derived from a pseudo-random number generator (PRNG) or a hardware-based entropy source. The random seed ensures that each health assessment trial utilizes a unique subset of computing nodes, thereby increasing the statistical reliability of the health test results.

The trial sampling sub-module of the randomization module 142 may further be configured to control the trial count threshold for node health evaluations. The trial count threshold defines the minimum number of randomized tests required to achieve a statistically significant confidence level for node health assessments. For instance, if a node repeatedly fails performance benchmarks across multiple trials, the trial sampling sub-module may flag the node for further assessment by the node component assessment module 160.

In some embodiments, the randomization module 142 may also be capable of adaptive node reshuffling. If a node consistently underperforms but does not meet a defined fault threshold, the module may initiate additional randomized trials involving alternate node pairings. This adaptive mechanism helps further isolate fault behavior patterns across the cluster.

Additionally, or alternatively, the randomization module 142 may be configured to store randomization parameters and historical data regarding previously tested node pairings. This historical data may be stored in a health state logging repository/database or the like and referenced to prevent repetitive testing of the same nodes in future health assessments, ensuring an optimized use of cluster resources.

In operation, the randomization module 142 may interface with the task scheduler 130 to ensure that randomized health assessments are completed prior to the scheduled job execution start time.

### 1.3 Automated Task Scheduler

The task scheduler 130 preferably functions as an orchestration layer that automatically facilitates a node health assessment. In a preferred embodiment, the task scheduler 130 may function to integrate node health assessments directly into an operational workflow of the cluster of computing nodes 140. Accordingly, the task scheduler 130 may be multi-faceted in its automated application of node health assessments on a predetermined schedule or dynamically during a pre-job deployment of a batch of computing nodes. It shall be recognized that the task scheduler 130 may sometimes be referred to herein as an “automated task scheduler” or a “computing task scheduler”.

In one or more embodiments, the task scheduler 130 may function to continually and/or periodically monitor a state of computing nodes within the cluster of computing nodes 140 to identify idle computing nodes that are not currently allocated to user jobs. In such embodiments, the task scheduler 130 may batch the idle computing nodes to the node testing queue 144 for a node health assessment.

Additionally, or alternatively, in one or more embodiments, the task scheduler 130 may function programmed or configured to automatically execute node health tests. In such embodiments, the task scheduler 130 may be programmed or configured with node health testing parameters thereby enabling the task scheduler 130 to identify candidate computing nodes that may be eligible for a node health assessment.

As a non-limiting example, the health testing parameters may include one or more node health assessment criteria including non-interference automated node testing instructions. In such example, the non-interference automated node testing instructions, when executed by the task scheduler 130, prioritizes for the node health assessment computing nodes of the plurality of idle nodes without a scheduled computing task while bypassing computing nodes of the plurality of idle nodes with scheduled computing tasks.

It shall be recognized that the task scheduler 130 may be configured and/or encoded with any suitable set of instructions that enable the task scheduler 130 to perform the processes, steps, and/or methods described herein including, but not limited to, those described in method 200 and the methods of the incorporated patent applications.

### 1.4 Cluster of Computing Nodes

The cluster of computing nodes 140 preferably includes a plurality of distinct computing nodes where each distinct node comprises a computer. In a preferred embodiment, the computer typically includes a server-grade machine, equipped with one or more of central processing units (CPUs), graphical processing units (GPUs), both, or similar processing components capable of executing tasks and running applications. In one or more embodiments, the plurality of distinct computing nodes in a cluster may include network interconnects comprising high-speed communication pathways that link the computing nodes together, facilitating rapid data transfer. One or more examples of network interconnects may include, but should not be limited to, InfiniBand, Ethernet, fiber-optic connections that may enable the computing nodes to operate in concert for distributed computing tasks.

Additionally, or alternatively, a cluster of computing nodes may include a storage system having an associated memory or data storage solutions that may range from local disk drives within each computing node of the cluster of computing nodes 140 to shared storage systems, such as storage area network (SAN) or network attached storage (NAS), accessible by all computing nodes in cluster 140 for distributed file systems and data persistence. In a preferred embodiment, the cluster of computing nodes 140 preferably employs a parallel file system that allows multiple computing nodes to access and process data simultaneously, which may increase throughput and efficiencies of the computing nodes.

### 1.5 Subsystem for Faulty Component Detection

In one or more embodiments, system 100 includes the subsystem 150 for enhanced identification and/or detection of faulty components of a suspected unhealthy computing node, as shown by way of example in FIG. 1A. Subsystem 150 preferably functions to evaluate a component health of a target computing node that may have been classified as being unhealthy. That is, in one or more embodiments, subsystem 150 in operation may function to identify and/or characterize one or more faulty components of a target computing node by executing a component node health assessment for one or more hardware and/or software components of the target computing node.

In some embodiments, the subsystem 150 may include or may be in operable communication with a repair queue 155, a node component assessment module 160, a repair module 170, and a qualification module 180. The repair queue 155 preferably includes a data structure or the like storing a listing or mapping of one or more computing nodes having a classification of an unhealthy state. In other words, the repair queue 155 preferably functions to itemize computing nodes that may need repair resulting from non-performant components or similar hardware or software failures. The repair queue 155, in such embodiments, may include a listing of unhealthy computing nodes together with associated node health assessment data observed or collected from one or more upstream health assessments (e.g., node health assessment module 120 or the like).

The node component assessment module 160, which is sometimes referred herein as the “node component health assessment module” preferably functions to assess a relative health of the components of a target computing node. In some embodiments, the node component assessment module 160 sources or identifies a target computing node for an assessment from repair queue 155, however, it shall be recognized that node component assessment module 160 may identify or receive a target computing node for an assessment from any source. In one or more embodiments, the node component assessment module 160 may function to prepare the components of a target computing node for testing by generating a plurality of unique combination of node component pairs based on an input of a listing or the like of the components of the target computing node and a listing or the like of the components of a healthy (i.e., golden model) target computing node. In a preferred embodiment, node component health assessment module 160 may function to compute a Cartesian product between the set of components of the target computing node (e.g., unhealthy computing node) and the set of components of the healthy computing node. As a result, node component health assessment module 160 may function to generate or output a listing or a mapping of all possible unique pairings between the components of the target computing node and the healthy computing node for peer-to-peer testing and/or the like.

Additionally, or alternatively, node component assessment module 160 may have access to a node component test suite that includes a plurality of tests for evaluating various components of a computing node. In some embodiments, node component assessment module 160 may implement a test selection matrix (not shown) that includes a mapping between distinct components mapped to or associated with one or more available tests for evaluating the associated components.

In use, node component assessment module 160 preferably performs an assessment of the components of a target computing node and may function to output one or more signals or classifications indicating whether a component of the target computing node is healthy or faulty. In the circumstances in which a component is classified by node component assessment module 160 as faulty, node component assessment module 160 may route data associated with the component classified as being faulty (i.e., the faulty node component) to repair module 170 for remediating the one or more faults or defects of the target computing node.

In one or more embodiments, once a computing node has been repaired via one or more operations associated with the repair module 170, the qualification module 180 may be implemented for ensuring that the repaired computing node is healthy and readied to return to service. In such embodiments, the qualification module 180 may function to execute a standard suite of health tests against the repaired computing node that may confirm or validate that the repairs to the repaired computing node are successful. In a variation, the qualification module 180 may function to execute a select set of health tests based on the one or more node components that were repaired. In such variation, the qualification module 180 may function to select one or more tests that map to a fault type or previously faulty node components for qualifying the repaired computing node. In response to a successful qualification (e.g., satisfaction of the one or more node health tests), the qualification module 180 may function to flag and/or identify the repaired computing node as being ready for service. Conversely, if the qualification is unsuccessful, the qualification module 180 may function to route the repaired computing node upstream to one or more of the health assessment module 120, the subsystem 150, and/or any other module or component of the system 100 for identifying a health state of the repaired computing node and/or fault characterization of one or more components of the repaired computing node.

### 2. Method of Randomly Sampling Trial Pairs for Initializing a Node Health Test

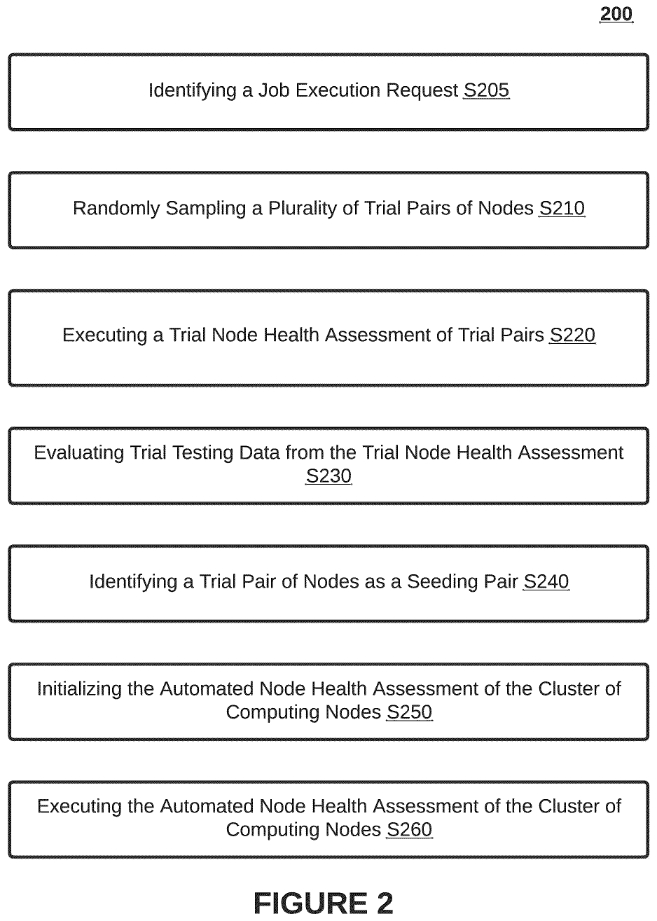

As shown in FIG. 2, a method 200 for randomly sampling trial pairs of computing nodes for initializing a node health assessment of a cluster of computing nodes includes identifying a job execution request S205, randomly sampling, by an automated task scheduler, a plurality of trial pairs S210, executing a trial node health assessment for each of the plurality of trial pairs of computing nodes S220, evaluating trial testing data obtained from the trial node health assessment of each trial pair S230, identifying at least one trial pair of the plurality of trial pairs of computing nodes as a seeding pair S240, initializing the automated node health assessment of the cluster of computing nodes based on the performance metrics of the seeding pair S250, executing the automated node health assessment across the entirety of the cluster of computing nodes S260.

### 2.05 Identifying Job Execution Request

S205, which includes identifying a job execution request, may function to detect, by an automated task scheduler, a request to execute a job within a cluster of computing nodes. In a preferred embodiment, the automated task scheduler may be configured to continuously or periodically monitor incoming job submission interfaces or job queues that may be accessible within a cluster management environment. The job execution request may originate from a user or an automated process and may specify a set of requirements or attributes related to the job, such as computational resources, priority, or start time.

Additionally, or alternatively, the automated task scheduler may function to actively listen for job submission signals or queries that indicate a new job request or may be configured to retrieve job requests from a designated job queue or job submission interface. In one or more embodiments, the job request may include metadata such as job identification, job type, required resources (e.g., CPU cores, memory, storage), anticipated runtime, and user-defined constraints or preferences. The automated task scheduler may parse and interpret the metadata to identify key parameters and characteristics of the job execution request.

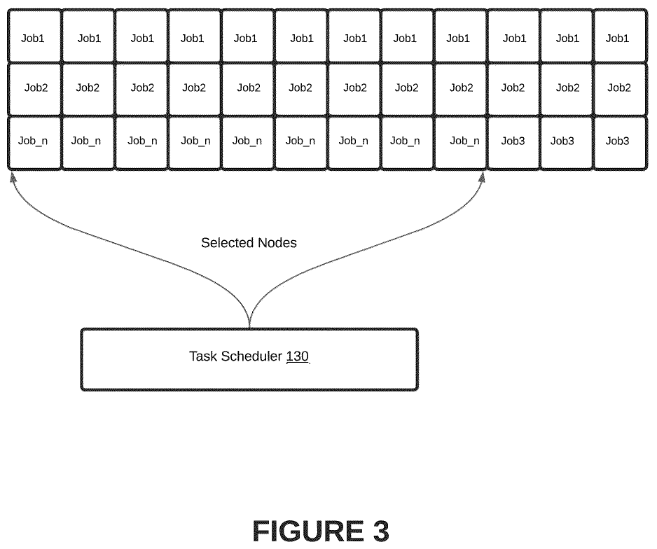

Accordingly, the automated task scheduler may, in one or more embodiments, function to analyze the job execution request and determine a target set of computing nodes within the cluster that are capable of executing the requested job, as shown by way of example in FIG. 3. This analysis may include evaluating the computational requirements of the job against the available resources within the cluster. In some embodiments, the automated task scheduler may employ predefined job scheduling policies or algorithms, such as load balancing, fairness, or priority-based scheduling, to identify an optimal target set of computing nodes.

In response to identifying the job execution request, S205 may cause the automated task scheduler to perform a random sampling of the target cluster of computing nodes for seeding a subsequent node health assessment. Additionally, S205 may cause the automated task scheduler to reserve the identified target set of computing nodes for the execution of the job at a future start time. In one or more embodiments, reserving the target set may involve updating the cluster management system's resource allocation records to temporarily mark the selected computing nodes as “reserved” or “allocated” for the specified job, thereby preventing conflicting job assignments.

### 2.10 Randomly Sampling Computing Nodes

S210 may include randomly sampling, by an automated task scheduler, a plurality of trial pairs of computing nodes from a cluster of computing nodes. The automated task scheduler may be in direct or indirect signal communication with each of the plurality of computing nodes within the cluster of computing nodes to ensure continuous monitoring and control of node selection. The automated task scheduler may randomly sample computing nodes from the cluster of computing nodes based on an operational state of the cluster. The automated task scheduler may determine that the cluster size satisfies or exceeds a predetermined threshold before initiating the sampling process to ensure statistical reliability of the subsequent health assessment results.

The automated task scheduler may be configured to implement a random sampling algorithm, such as a uniform random sampling technique, stratified sampling, or weighted random selection, where each computing node has a non-zero probability of being selected for inclusion in a trial pair. Random sampling may also be constrained by cluster-specific parameters, including node availability, connectivity, and historical performance data. In some embodiments, the automated task scheduler may dynamically adjust the probability of node selection based on the operational history or error rates associated with each computing node. Additionally, or alternatively, the random sampling of computing nodes may involve generating a randomized index or seed to select trial pairs, ensuring variability in node combinations across multiple iterations.

The automated task scheduler may execute the random sampling process across the entire cluster or target specific subregions within the cluster of computing nodes. For example, the automated task scheduler may ensure that the trial pairs represent a diverse sampling of nodes from different logical units within the cluster, such as pods, racks, or boundary regions, to ensure comprehensive coverage across the cluster. In some embodiments, random sampling may prioritize pairs spanning across multiple pods to assess cross-pod connectivity and performance consistency. A pod, as referred to herein, may represent a logical grouping of computing nodes within the cluster, where each pod shares a common networking infrastructure or set of resources or may be a subset of the cluster of computing nodes comprising a defined number of computing nodes interconnected through a local communication infrastructure, such as a leaf-spine network architecture.

In one or more embodiments, the random sampling process, as executed by the automated task scheduler, may be performed using a randomization module configured to shuffle node pairings and select computing nodes from multiple regions of the cluster, such as distinct pods. In some embodiments, the random sampling may target nodes from both within a single pod and across multiple pods, thereby accounting for both intra-pod and inter-pod communication variances.

The automated task scheduler may further verify the selected computing nodes for active availability prior to completing the trial pair selection. Verifying active availability may include evaluating node-specific operational metrics such as CPU utilization, memory availability, network connectivity, and job assignment status. Nodes operating below predefined performance thresholds may be excluded from the final selection pool to avoid performance skewing during subsequent health assessments.

The automated task scheduler may form trial pairs by pairing individual computing nodes selected during the random sampling process. A trial pair may refer to a temporary logical association between two computing nodes for the purpose of conducting bi-directional health assessments during the subsequent phases of the method. Each trial pair may be identified using a unique pair identifier to facilitate tracking and performance comparison during later phases of the automated node health assessment.

Accordingly, the automated task scheduler may apply a trial sampling threshold that specifies the minimum number of node pairs to be tested during the randomized selection phase. In one or more embodiments, the trial sampling process may continue until a predefined confidence level is met, ensuring a statistically significant dataset for fault detection analysis.

In some embodiments, random sampling performed during S210 may be constrained by topological considerations. For example, the task scheduler may prioritize selecting computing nodes that are distributed across different network segments to ensure a diverse range of test results. This technique minimizes the risk of localized network conditions skewing the results of the node health assessment.

Additionally, or alternatively, S210 may include the task scheduler dynamically adjusting the node sampling strategy based on real-time performance feedback received during the initial trials. For instance, if a node is observed to consistently return anomalous results, the scheduler may expand the sampling set or initiate a more targeted re-sampling process focusing on the surrounding nodes.

The automated task scheduler may maintain a sampling log that records the identifiers of each trial pair, the selection criteria used, and the operational state of each node at the time of sampling. This sampling log may be stored in a persistent data repository for traceability and reproducibility of the health assessment process.

A technical benefit of the random sampling process described in S210 may include ensuring a statistically diverse and representative selection of nodes within the cluster for health assessment, thereby reducing the risk of localized bias in the health metrics collected. Random sampling across pods and boundary regions may also enhance the detection of localized network anomalies or hardware faults that could be obscured in a less diverse selection. Additionally, enforcing a minimum cluster size threshold before initiating the random sampling process may ensure statistical relevance in the results, leading to more reliable cluster health assessments.

In response to completing the random sampling, S210 may generate a trial node set comprising the selected trial pairs of computing nodes, which will subsequently be tested during S220 for performance stability analysis and seeding pair identification.

### 2.20 Executing a Trial Node Health Assessment

S220 may include executing a trial node health assessment for each of the plurality of trial pairs of computing nodes identified during the random sampling phase. The trial node health assessment may be performed by a health assessment module operating in conjunction with the automated task scheduler, where the health assessment module is configured to systematically test the operational stability and reliability of the computing nodes within each trial pair. The health assessment module may initiate a controlled testing protocol across each trial pair to establish a baseline measurement of node connectivity, data integrity, and overall cluster performance.

The trial node health assessment may include performing bi-directional health testing between the computing nodes of each trial pair. Bi-directional health testing may involve the exchange of test data packets in both directions between the computing nodes of the trial pair to ensure symmetrical performance evaluation. The bi-directional health testing may verify consistency of data transmission in both sending and receiving directions, thereby detecting asymmetric network faults or inconsistencies that could affect node performance. The health assessment module may initiate multiple iterations of bi-directional data transmission to ensure statistical accuracy in the health assessment results.

The trial node health assessment may further include measuring multiple performance metrics for each trial pair of computing nodes. Performance metrics may include, but are not limited to, latency, packet delivery success rates, node responsiveness, throughput consistency, and error rates. Latency measurements may refer to the time required for a data packet to travel from one computing node to another and return to the originating node. Packet delivery success rates may measure the ratio of successfully transmitted data packets to the total number of packets sent during the health test. Node responsiveness may involve measuring the time required for a computing node to acknowledge receipt of a test command or signal. Throughput consistency may refer to the sustained data transfer rate between the computing nodes, while error rates may indicate transmission errors, packet drops, or data corruption during the health assessment.

The health assessment module may further perform diagnostic tests to assess the computational stability of each node within the trial pair. Computational stability testing may include assessing central processing unit (CPU) load, memory allocation stability, and network interface card (NIC) performance during the trial node health assessment. In one or more embodiments, the health assessment module may initiate synthetic workloads during the trial node health assessment to simulate varying load conditions and assess performance under stress testing scenarios.

The trial node health assessment may include evaluating data packet integrity using checksums or cryptographic hashes. The health assessment module may compare the checksum of the transmitted data with the checksum of the received data to verify whether packet data integrity is maintained during transmission. Any discrepancies identified in the checksum comparison may be logged as data integrity errors, which may be used in subsequent evaluation steps.

The trial node health assessment may be controlled by a time-based testing window, during which the health assessment module collects multiple rounds of health data for each trial pair. The health assessment module may establish a standardized testing duration and may repeat tests at predetermined intervals to ensure repeatability of results. The health assessment module may store all collected health data in a trial pair health data repository, where each record is associated with a unique trial pair identifier and timestamp.

At least one technical benefit of the execution of the trial node health assessment described in S220 may include providing a systematic and scalable mechanism for detecting network anomalies and hardware inconsistencies across distributed computing nodes. The use of bi-directional health testing may ensure a comprehensive assessment of data transmission reliability while measuring multiple performance metrics enhances the identification of complex faults such as asymmetric packet loss or node-level instability. Conducting the trial node health assessment with repeatable test iterations may further ensure statistical reliability and accuracy of the cluster's health profile.

### 2.3 Evaluating Trial Testing Data

S230 may include evaluating trial testing data obtained from the trial node health assessment of each trial pair of computing nodes within the cluster of computing nodes. The evaluation of trial testing data may be performed by a data evaluation module communicatively coupled with the health assessment module and the automated task scheduler. The data evaluation module may be configured to receive the performance metrics and health indicators generated during the bi-directional health testing of S220 and systematically analyze the collected data for performance consistency, stability, and error detection.

The data evaluation module may analyze performance metrics and health indicators for each trial pair of computing nodes, where performance metrics and health indicators may include latency, packet delivery success rates, throughput stability, node responsiveness, error rates, checksum validation results, and computational load metrics (e.g., CPU and memory utilization). The evaluation may involve statistical analysis techniques to identify deviations or fluctuations in the collected metrics. For example, latency measurements may be averaged across multiple rounds of bi-directional testing to determine mean latency and standard deviation for a given trial pair, while packet delivery success rates may be expressed as a percentage of successful transmissions relative to total attempts.

Analyzing performance metrics may further include computing derived metrics, such as jitter (the variation in latency over multiple transmission attempts) and average error rates across multiple test cycles. The data evaluation module may compare observed metrics against predefined performance stability thresholds stored in memory. Stability thresholds may be dynamically adjustable based on system configurations and operational contexts, such as cluster size, current workload, and historical performance patterns. The evaluation may further involve the detection of outlier conditions where trial pairs exhibit significant deviations from expected performance ranges. Outliers may be identified using statistical techniques such as Z-score calculation or interquartile range (IQR) filtering.
S230 may include identifying variability, stability, and other conditions impacting the node health assessment. Identifying variability may involve detecting inconsistencies in performance metrics across multiple test iterations. For example, a trial pair with fluctuating packet delivery success rates across multiple rounds of bi-directional testing may be flagged as a variable node pair. Identifying stability may involve determining whether performance metrics remain consistent across all rounds of testing. Trial pairs demonstrating minimal deviation from baseline performance measurements may be classified as stable node pairs. Other conditions impacting node health assessments may include network congestion indicators, hardware faults, or asymmetric data transmission behavior.

The data evaluation module may generate a trial pair health report summarizing the results of the evaluation for each trial pair. The trial pair health report may include an overall health score for the trial pair, individual performance metrics, statistical summaries, and a classification of the trial pair as either stable, variable, or anomalous. The trial pair health report may be stored in a trial assessment repository along with the raw testing data for historical analysis and auditing purposes.

In one or more embodiments, the data evaluation module may generate a diagnostic alert if performance metrics for a trial pair fall below predefined stability thresholds. The diagnostic alert may trigger a re-execution of the trial node health assessment for the flagged trial pair or prevent the flagged trial pair from being selected as a seeding pair for further health assessments in subsequent steps.

A technical benefit of the evaluation of trial testing data described in S230 may include enabling the detection of unstable or underperforming computing nodes prior to initiating a broader cluster-wide health assessment. The systematic evaluation of multiple performance metrics and the identification of variability and stability ensures a more accurate representation of the cluster's health state. Furthermore, the use of statistical analysis and dynamic performance thresholds may reduce false positives in node failure detection and improve the reliability of subsequent automated node health assessments.

### 2.4 Identifying Seeding Pairs

S240 may include identifying at least one trial pair of the plurality of trial pairs of computing nodes as a seeding pair for initializing the automated node health assessment of the cluster of computing nodes. The identification of the seeding pair may be performed by a seeding pair selection module communicatively coupled to the data evaluation module and the health assessment module. The seeding pair selection module may be configured to assess performance metrics and health indicators associated with each trial pair of computing nodes previously evaluated in S230 and systematically identify a trial pair that satisfies stability and performance criteria for initializing the cluster-wide health assessment process.

The seeding pair selection module may determine the seeding pair based on performance metrics satisfying or exceeding predefined performance stability thresholds. Performance metrics used for determining the seeding pair may include latency stability, packet delivery success rates, throughput consistency, node responsiveness, error rates, and checksum validation accuracy. Performance stability thresholds may be preconfigured within a stability threshold repository and may include defined numerical ranges or boundary values representing optimal node performance. For example, a performance stability threshold for packet delivery success rate may be set at 99% or higher, while a latency threshold may be defined as below 20 milliseconds with a variance below a predefined jitter margin.

The determination of the seeding pair may involve comparing the performance metrics of each trial pair against the predefined performance stability thresholds to identify trial pairs with metrics that consistently meet or exceed the stability criteria across multiple rounds of bi-directional health testing. In one or more embodiments, the determination may include computing a composite health score for each trial pair based on weighted performance metrics. For example, latency and packet delivery success rates may be weighted higher in the composite health score than error rates or minor network fluctuations.

The seeding pair selection module may implement a ranking algorithm to prioritize trial pairs with the highest composite health scores. In one or more embodiments, the trial pair with the highest composite health score or the lowest performance variability may be automatically selected as the seeding pair. The ranking algorithm may further be configured to handle cases where multiple trial pairs meet or exceed the stability thresholds. In such cases, the seeding pair selection module may select the trial pair with the most balanced bidirectional health metrics or, alternatively, randomly select from the top-performing trial pairs to avoid bias in node selection.

The seeding pair selection module may also ensure diversity in the selection of the seeding pair by evaluating the physical distribution of the trial pairs within the cluster of computing nodes. For example, the seeding pair may be selected from trial pairs belonging to different logical regions, such as distinct pods, racks, or subnets, to ensure the health assessment covers a wide distribution across the cluster. In such embodiments, the seeding pair selection module may access node topology data to verify that the selected trial pair is not constrained to a single physical boundary within the cluster.

Upon identifying the seeding pair, the seeding pair selection module may generate a seeding pair record, which may include a unique seeding pair identifier, the associated performance metrics, and a confirmation timestamp indicating when the pair was designated as the seeding pair. The seeding pair record may be stored in a seeding pair repository and may be referenced in subsequent steps of the automated node health assessment process.

Additionally, or alternatively, if no trial pair satisfies the predefined performance thresholds during the initial trial assessments, the task scheduler may trigger an adaptive re-sampling process, returning to S210 to repeat the random sampling and trial health assessment steps with a new selection of trial pairs. This ensures the reliability of the selected seeding pair before proceeding with the cluster-wide health assessment.

In one or more embodiments, the task scheduler may identify multiple seeding pairs to ensure redundancy during the health assessment. This approach may be useful in large-scale clusters or multi-computing node jobs where multiple health assessments are performed concurrently across different regions or pods within the cluster.

A technical benefit of identifying the seeding pair for health assessment initialization described in S240 may include establishing a reliable performance baseline for conducting subsequent cluster-wide health assessments. By selecting a trial pair with optimal performance metrics and low variability, the automated node health assessment process can ensure that initial health measurements are based on nodes with stable connectivity and consistent performance. Additionally, the selection of a diverse seeding pair may reduce the risk of localized network issues skewing the broader health assessment results. The systematic determination of the seeding pair based on composite health scoring and threshold comparisons may further ensure repeatability and accuracy in node selection, leading to a more effective and scalable cluster-wide health assessment.

### 2.5 Initializing the Automated Node Health Testing

S250 may include initializing the automated node health assessment of the cluster of computing nodes based on the performance metrics of the seeding pair identified in S240. That is, S250 may function to establish a systematic process for launching a comprehensive health evaluation across the entire cluster based on the performance stability of a seeding pair of computing nodes. The initialization of the automated node health assessment may be performed by a health assessment initialization module, which may be communicatively coupled with the seeding pair selection module, the data evaluation module, and the automated task scheduler. The health assessment initialization module may be configured to utilize the performance metrics of the seeding pair as a reference point for assessing the overall health of the cluster of computing nodes. Accordingly, the initialization phase ensures that the health assessment is grounded in a reliable reference point, improving the accuracy and consistency of the health analysis across the distributed computing cluster.

The seeding pair, selected based on its performance stability metrics from the trial health assessments, serves as a benchmark reference for evaluating the remaining nodes in the cluster. The automated task scheduler may confirm that the performance metrics of the seeding pair satisfy a predefined set of performance stability thresholds before proceeding with full cluster-wide testing. Accordingly, initializing the automated node health assessment may involve designating the seeding pair as the reference or baseline set of computing nodes for subsequent health assessments within the cluster. The health assessment initialization module may retrieve the performance metrics and health indicators associated with the seeding pair from a seeding pair repository. The retrieved performance metrics may include latency, packet delivery success rates, error rates, throughput consistency, and checksum validation results, all of which were previously evaluated and validated for performance stability.

Additionally, or alternatively, initializing the automated node health assessment may involve establishing a baseline dataset derived from the performance metrics of the seeding pair. The baseline dataset may include one or more of the following parameters including, but not limited to, latency baseline, packet delivery success rate, bandwidth utilization, node responsiveness, and/or the like.

The health assessment initialization module may establish the seeding pair as the reference set by designating the average performance metrics of the seeding pair as the baseline health metrics for comparison during the broader cluster health evaluation. Establishing the seeding pair as a reference set may include storing the baseline metrics in a cluster health metrics repository, where the stored data may serve as the comparative standard for the subsequent health assessments conducted on additional computing nodes. The baseline health metrics may be calculated using an aggregation of historical performance data collected during prior rounds of bi-directional health testing for the seeding pair to ensure consistency and statistical reliability.

The initialization of the automated node health assessment may include verifying the readiness of the seeding pair before proceeding with cluster-wide assessments. The health assessment initialization module may perform a verification process by executing a final health check on the seeding pair, including a brief round of latency measurements, packet transmission tests, and error rate validation. If the seeding pair fails to meet the predefined stability thresholds during the verification phase, the health assessment initialization module may revert to the seeding pair selection module to identify an alternative trial pair from the previously evaluated trial pairs.

Upon successful verification, the health assessment initialization module may initiate the propagation phase, where the seeding pair serves as the starting point for the automated node health assessment. The propagation phase may include systematically expanding the health assessment to additional computing nodes by selecting neighboring nodes within the cluster and comparing their performance metrics against the established baseline health metrics of the seeding pair. The selection of additional nodes for health assessment may be prioritized based on physical proximity, network topology, or historical performance relationships between the seeding pair and neighboring nodes.

The health assessment initialization module may generate a seeding pair confirmation record containing metadata associated with the seeding pair, including the unique seeding pair identifier, baseline health metrics, and a timestamp indicating the commencement of the automated node health assessment. The seeding pair confirmation record may be stored in the health metrics repository for auditability and historical analysis of the cluster's health state.

Additionally, or alternatively, in some embodiments, the initialization process may also account for network topology considerations. If the seeding pair is drawn from a specific pod within the cluster, the task scheduler may determine whether the initial health tests should remain localized within that pod before expanding to other regions of the cluster. This approach helps account for topological variances that could impact node-to-node performance metrics.

A technical benefit of initializing the automated node health assessment as described in S250 may include the establishment of a statistically reliable performance baseline for evaluating the health of the entire cluster of computing nodes. By selecting a stable seeding pair as the reference set, the automated node health assessment can ensure uniform comparison metrics across the cluster, reducing the likelihood of inaccurate health evaluations. Furthermore, using a performance-verified seeding pair may enhance the consistency and reliability of the health assessment process by preventing the propagation of erroneous results from unstable nodes. The initialization of the automated node health assessment from a verified seeding pair may further optimize cluster-wide diagnostics by enabling a systematic and scalable expansion of the health assessment while maintaining data integrity and diagnostic precision.

### 2.6 Executing a Cluster-Wide Automated Node Health Assessment

S260 may include executing the automated node health assessment across the entirety of the cluster of computing nodes. The automated node health assessment may be initiated by a cluster health assessment module, which may be communicatively coupled with the health assessment initialization module, the data evaluation module, and the automated task scheduler. The cluster health assessment module may be configured to systematically expand the health assessment from the seeding pair to all computing nodes within the cluster, ensuring comprehensive evaluation of node performance and system stability.

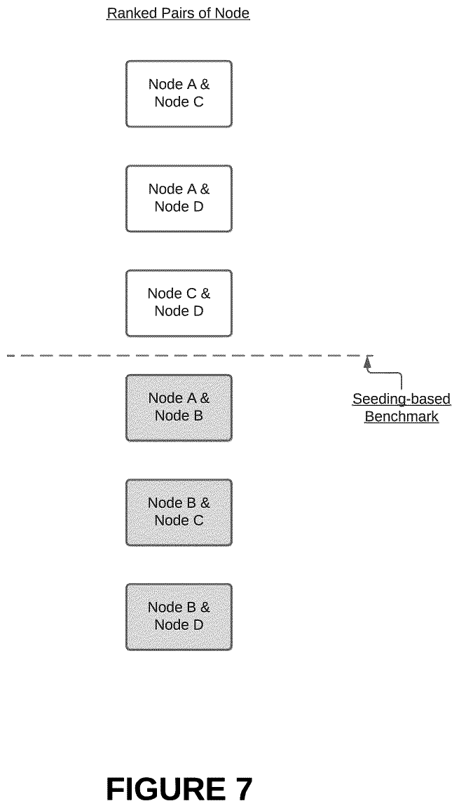

The automated node health assessment may utilize the seeding pair as a performance benchmark for evaluating the health status of other computing nodes within the cluster of computing nodes, as shown by way of example in FIG. 7. The cluster health assessment module may retrieve the baseline performance metrics established during the seeding pair evaluation, including latency, packet delivery success rates, node responsiveness, error rates, and throughput stability. These performance metrics may be stored in a cluster health metrics repository and serve as comparative thresholds for the broader cluster health assessment.

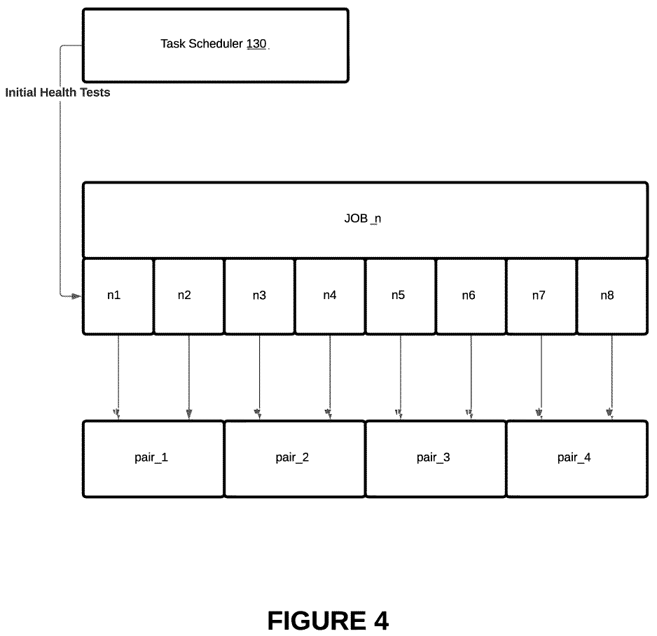

The cluster health assessment module may propagate the health assessment process by expanding outward from the seeding pair to assess additional computing nodes in the cluster. In one or more embodiments, the propagation may occur through an iterative or parallelized node evaluation process, where subsets of computing nodes are assessed concurrently to optimize efficiency, as shown by way of example in FIG. 4. Each additional computing node evaluated during S260 may be compared against the baseline performance metrics of the seeding pair to determine whether the computing node meets, exceeds, or falls below the established stability thresholds.

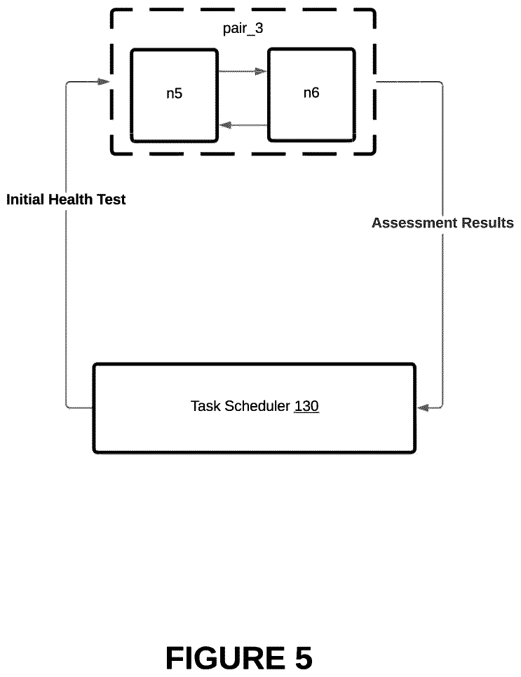

As shown by way of example in FIG. 5, the health assessment for each additional computing node may involve bi-directional performance testing similar to the processes described in S220, including the exchange of test data packets between nodes and the measurement of key performance metrics such as latency, packet delivery success rates, and error rates. The cluster health assessment module may perform multiple rounds of testing for each computing node to ensure statistical accuracy and repeatability in the performance measurements.

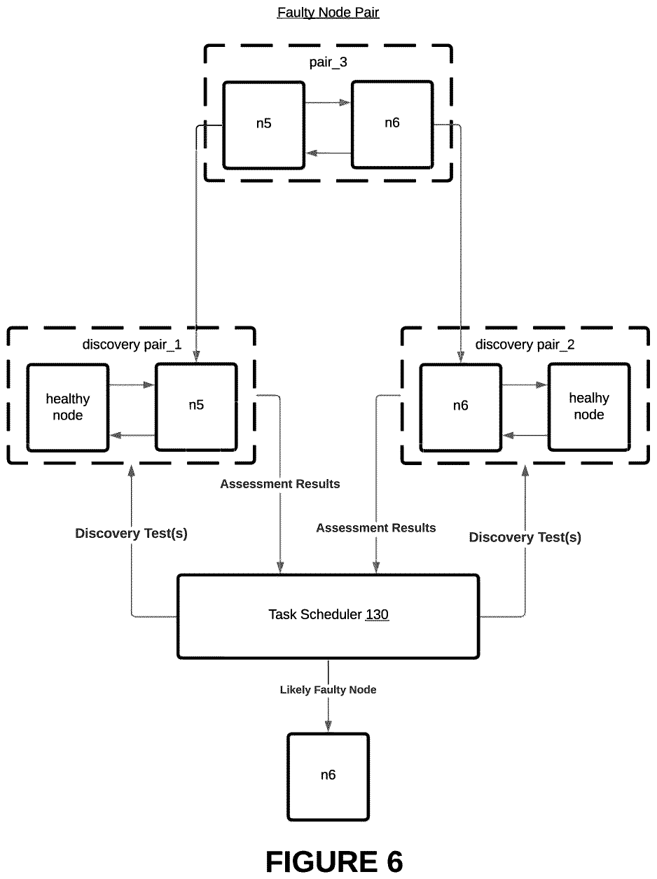

The cluster health assessment module may further classify the health status of each computing node based on the comparison results with the seeding pair benchmarks. Each computing node may be categorized as either: (1) healthy, if all performance metrics meet or exceed the seeding pair benchmarks; (2) marginal, if the performance metrics fall within a predefined deviation range relative to the seeding pair benchmarks; or (3) degraded, faulty, or unhealthy, if the performance metrics fall below the stability thresholds established by the seeding pair metrics, as shown by way of example in FIG. 6. Each health status classification may be associated with a unique health status identifier stored in a cluster health report.

In one or more embodiments, the cluster health assessment module may continuously monitor the propagation of the health assessment process to ensure coverage across the entire cluster of computing nodes. The propagation process may include the systematic expansion to adjacent computing nodes based on physical proximity, network topology, or historical node relationships. The cluster health assessment module may update a cluster coverage map to visually represent the progression and completion status of the health assessment across the cluster.

The cluster health assessment module may further generate a cluster health summary upon the completion of the health assessment process. The cluster health summary may include performance metrics for each computing node, comparative results relative to the seeding pair benchmarks, and an overall cluster health score representing the aggregate stability and performance of the cluster. The cluster health summary may be stored in the cluster health metrics repository and may be accessible for future performance audits or historical analysis.

A technical benefit of executing the cluster-wide automated node health assessment as described in S260 may include providing a systematic and scalable mechanism for evaluating the health and stability of a distributed cluster of computing nodes. By using a verified seeding pair as a performance benchmark, the automated node health assessment may ensure consistent evaluation criteria across all computing nodes, reducing the risk of performance discrepancies and false failure detections. Additionally, the ability to classify computing nodes based on health status may facilitate targeted maintenance actions and proactive error mitigation, ensuring sustained cluster performance and reliability. The iterative propagation of the health assessment may further optimize diagnostic coverage, ensuring that every computing node in the cluster undergoes thorough and consistent performance evaluation.

### 3. Computer-Program Product

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that similar to a method with contingent steps, a system or computer readable storage medium can repeat the steps of a method as many times as are needed to ensure that all of the contingent steps have been performed.

Although omitted for conciseness, the preferred embodiments include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A method for initializing an automated computing node health assessment based on computing nodes randomly sampled from a cluster of computing nodes, the method comprising:
randomly sampling, by an automated task scheduler, a plurality of trial pairs of computing nodes from a cluster of computing nodes;
executing, by the automated task scheduler, a trial node health assessment for each of the plurality of trial pairs of computing nodes, wherein the trial node health assessment includes executing a bi-directional testing between computing nodes within each of the plurality of trial pairs of computing nodes;
evaluating trial testing data obtained based on the execution of the trial node health assessment;
identifying at least one trial pair of the plurality of trial pairs of computing nodes as a seeding pair of computing nodes for initializing an automated node health assessment of an entirety of the cluster of computing nodes;
initializing the automated node health assessment based on performance metrics of the seeding pair of computing nodes satisfying one or more performance stability thresholds; and
executing the automated node health assessment of the cluster of computing nodes based on the initialization using the seeding pair.

2. The method according to claim 1, wherein initializing the automated node health assessment includes:
setting the seeding pair of computing nodes as an initial or a first set of computing nodes for executing the automated node health assessment, and
setting performance metrics obtained from an assessment of the seeding pair under the automated node health assessment as one or more benchmarks of performance for evaluating a performance of test pairs of computer nodes of the cluster of computing nodes.

3. The method according to claim 1, further comprising:
identifying at least one pair of the plurality of trial pairs of computing nodes as an anomalous pair of computing nodes based on the anomalous pair of computing nodes failing to satisfy the one or more performance stability thresholds; and
in response to identifying the anomalous pair of computing nodes, automatically re-executing the random sampling a new plurality of trial pairs of computing nodes from the cluster of computing nodes and further executing the trial node health assessment using the new plurality of trial pairs of computing nodes.

4. The method according to claim 3, further comprising:
bypassing or avoiding an assignment of one or more computing nodes of the anomalous pair of computing nodes as one or more seeding pairs of computing nodes used for initializing the automated node health assessment.

5. The method according to claim 1, wherein randomly sampling from the cluster of computing nodes includes:
randomly sampling computing nodes from multiple distinct pods of computing nodes, wherein each pod of the multiple distinct pods of computing nodes includes a plurality of computing nodes, and wherein the multiple distinct pods of computing nodes are interconnected via a communication spine; and
wherein at least a subset of trial pairs of the plurality of trial pairs of computing nodes comprises computing nodes from distinct pods of the multiple distinct pods.

6. The method according to claim 1, wherein randomly sampling from the cluster of computing nodes includes:
randomly sampling computing nodes of the cluster of computing nodes that are located along a boundary of a pod of computing nodes, and
wherein at least a subset of trial pairs of the plurality of trial pairs of computing nodes comprises computing nodes from the boundary of a pod of computing nodes.

7. The method according to claim 1, wherein the random sampling includes dynamically adjusting node selection based on historical performance data and operational status of computing nodes within the cluster of computing nodes.

8. The method according to claim 1, further comprising prioritizing the inclusion of computing nodes with historically stable performance metrics in the plurality of trial pairs to enhance the reliability of the trial node health assessment.

9. The method according to claim 1, further comprising generating diagnostic alerts for trial pairs exhibiting performance metrics below predefined stability thresholds and automatically excluding such trial pairs from subsequent seeding pair selection.

10. The method according to claim 1, wherein the automated node health assessment includes assessing intra-cluster communication performance by evaluating cross-pod latency and throughput between interconnected computing nodes.

11. The method according to claim 1, further comprising dynamically updating performance stability thresholds used for seeding pair determination based on real-time feedback from ongoing node health assessments.

12. The method according to claim 1, wherein the execution of the automated node health assessment includes leveraging a hierarchical topology of the cluster of computing nodes to sequentially assess subsets of nodes within defined network segments.

13. A system for initializing an automated computing node health assessment within a cluster of computing nodes, the system comprising:
a cluster of computing nodes configured to perform distributed computing operations;
an automated task scheduler communicatively coupled to the cluster of computing nodes, wherein the automated task scheduler is configured to:
randomly sample a plurality of trial pairs of computing nodes from the cluster of computing nodes;
execute a trial node health assessment for each of the plurality of trial pairs of computing nodes, wherein the trial node health assessment includes bi-directional testing between computing nodes within each of the plurality of trial pairs of computing nodes;
evaluate trial testing data obtained based on the execution of the trial node health assessment;
identify at least one trial pair of the plurality of trial pairs of computing nodes as a seeding pair of computing nodes based on performance metrics of the trial pairs satisfying or exceeding one or more performance stability thresholds;
initialize an automated node health assessment of the cluster of computing nodes using the seeding pair of computing nodes as a reference for health evaluation; and
execute the automated node health assessment across the entirety of the cluster of computing nodes based on the initialization using the seeding pair of computing nodes; and
a cluster health evaluation module configured to analyze and store performance metrics and node health assessment results for the cluster of computing nodes in a cluster health repository.

14. The system according to claim 13, wherein initializing the automated node health assessment includes:
setting the seeding pair of computing nodes as an initial or a first set of computing nodes for executing the automated node health assessment, and
setting performance metrics obtained from an assessment of the seeding pair under the automated node health assessment as one or more benchmarks of performance for evaluating a performance of test pairs of computer nodes of the cluster of computing nodes.

15. The system according to claim 13, wherein the automated task scheduler is further configured to:
identify at least one pair of the plurality of trial pairs of computing nodes as an anomalous pair of computing nodes based on the anomalous pair of computing nodes failing to satisfy the one or more performance stability thresholds; and
in response to identifying the anomalous pair of computing nodes, automatically re-execute the random sampling a new plurality of trial pairs of computing nodes from the cluster of computing nodes and further executing the trial node health assessment using the new plurality of trial pairs of computing nodes.

16. The system according to claim 13, further comprising:
bypassing or avoiding an assignment of one or more computing nodes of the anomalous pair of computing nodes as one or more seeding pairs of computing nodes used for initializing the automated node health assessment.

17. The system according to claim 13, wherein randomly sampling from the cluster of computing nodes includes:
randomly sampling computing nodes from multiple distinct pods of computing nodes, wherein each pod of the multiple distinct pods of computing nodes includes a plurality of computing nodes, and wherein the multiple distinct pods of computing nodes are interconnected via a communication spine; and
wherein at least a subset of trial pairs of the plurality of trial pairs of computing nodes comprises computing nodes from distinct pods of the multiple distinct pods.

18. A computer-program product comprising a non-transitory computer-readable medium having computer-executable instructions stored thereon, wherein the instructions, when executed by one or more processors, cause a computing system to perform operations comprising:
randomly sampling, by an automated task scheduler, a plurality of trial pairs of computing nodes from a cluster of computing nodes;
executing, by the automated task scheduler, a trial node health assessment for each of the plurality of trial pairs of computing nodes, wherein the trial node health assessment includes executing bi-directional testing between computing nodes within each of the plurality of trial pairs of computing nodes;
evaluating trial testing data obtained based on the execution of the trial node health assessment;
identifying at least one trial pair of the plurality of trial pairs of computing nodes as a seeding pair of computing nodes for initializing an automated node health assessment of an entirety of the cluster of computing nodes;
initializing the automated node health assessment based on performance metrics of the seeding pair of computing nodes satisfying one or more performance stability thresholds; and
executing the automated node health assessment of the cluster of computing nodes based on the initialization using the seeding pair of computing nodes.

19. The computer-program product according to claim 18, wherein initializing the automated node health assessment includes:
setting the seeding pair of computing nodes as an initial or a first set of computing nodes for executing the automated node health assessment, and
setting performance metrics obtained from an assessment of the seeding pair under the automated node health assessment as one or more benchmarks of performance for evaluating a performance of test pairs of computer nodes of the cluster of computing nodes.

20. The computer-program product according to claim 18, further comprising:
identifying at least one pair of the plurality of trial pairs of computing nodes as an anomalous pair of computing nodes based on the anomalous pair of computing nodes failing to satisfy the one or more performance stability thresholds; and
in response to identifying the anomalous pair of computing nodes, automatically re-executing the random sampling a new plurality of trial pairs of computing nodes from the cluster of computing nodes and further executing the trial node health assessment using the new plurality of trial pairs of computing nodes.
